(19) United States
(12) Patent Application Publication
(10) Pub. No.: US 2021/0094865 A1
(43) Pub. Date: Apr. 1, 2021

(54) METHODS OF FORMING GLASS-POLYMER STACKS FOR HOLOGRAPHIC OPTICAL STRUCTURE

(71) Applicant: CORNING INCORPORATED, Corning, NY (US)

(72) Inventors: Mark Francis Krol, Painted Post, NY (US); Karan Mehrotra, Painted Post, NY (US)

(21) Appl. No.: 17/038,961

(22) Filed: Sep. 30, 2020

Related U.S. Application Data
(60) Provisional application No. 62/908,680, filed on Oct. 1, 2019.

(51) Int. Cl. C03B 33/02; B32B 17/06; C03C 3/091

(52) U.S. Cl. CPC C03B 33/02; C03B 17/064; C03C 3/091; B32B 17/06

(57) ABSTRACT

A method for forming a glass stack, comprising: obtaining a glass sheet; selecting a plurality of portions of the glass sheet having a matching glass characteristic, wherein the glass characteristic is at least one of warp, bow, total thickness variation (TTV), and wedge; cutting a plurality of glass wafers from the selected portions of the glass sheet, and stacking the plurality of glass wafers to form a glass stack.

This application claims the benefit of priority under 35 U.S.C § 120 of U.S. Provisional Application Ser. No. 62/908,680 filed on Oct. 1, 2019, the content of which is relied upon and incorporated herein by reference in its entirety

### TECHNICAL FIELD

Embodiments of the present disclosure relate to glass sheets and glass substrates. More particularly, embodiments of the present disclosure relate to glass wafers or glass panels for optical light guide based augmented reality optical devices and for optical lightguide based back-lights for mobile devices.

### BACKGROUND

Numerous emerging applications, such as optical lightguide based augmented reality optical devices and optical lightguide based back-lights for mobile devices, require glass articles (e.g. glass wafers or glass panels) with refractive index attributes similar to traditional optical glasses while also having a thin planar shape (e.g. a thin glass wafer or thin glass panel). Such applications also require stringent geometrical attributes relative to planarity and smoothness and also require the glass refractive index to be matched to a suitable optical polymer where the polymer is used as a medium to implement additional optical functionality (e.g. lens arrays, surface relief gratings, holograms, holographic gratings, etc.).

Accordingly, there is a need in the art for glass articles with refractive index attributes similar to traditional optical glasses while also having a thin planar shape while having other advantageous properties and characteristics.

### SUMMARY OF THE CLAIMS

A first embodiments of the present disclosure includes a method for forming a glass stack, comprising: obtaining a glass sheet; selecting a plurality of portions of the glass sheet having a matching glass characteristic, wherein the glass characteristic is at least one of warp, bow, total thickness variation (TTV), and wedge; cutting a plurality of glass wafers from the selected portions of the glass sheet, and stacking the plurality of glass wafers to form a glass stack.

A second embodiments of the of the present disclosure includes a method for forming a glass-polymer stack, comprising: obtaining a glass sheet; cutting a plurality of glass wafers from portions of the glass sheet; selecting a plurality of glass wafers having a matching glass characteristic, wherein the glass characteristic is at least one of warp, bow, total thickness variation (TTV), and wedge; stacking the plurality of glass wafers to form a glass stack.

Other embodiments and variations of the present disclosure are discussed below

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. The appended drawings illustrate only typical embodiments of the disclosure and are not to be considered limiting of the scope, for the disclosure may admit to other equally effective embodiments.

FIG. 1 depicts a schematic representation of a glass-polymer stack in accordance with some embodiments of the present disclosure;

FIG. 2 depicts a schematic representation of a glass-polymer stack having an optical structure in accordance with some embodiments of the present disclosure;

FIG. 3 depicts a schematic representation of a glass-polymer stack having an optical structure in accordance with some embodiments of the present disclosure;

FIG. 4 depicts a schematic representation of a glass-polymer-glass stack having an optical structure in accordance with some embodiments of the present disclosure;

FIG. 5 shows a schematic representation of a forming mandrel used to make precision sheet in the fusion draw process; and

FIG. 6 shows a cross-sectional view of the forming mandrel of FIG. 1 taken along position 6.

FIG. 7 shows a schematic diagram of an exemplary glass wafer used to explain the definition of warp.

FIG. 8 shows a schematic diagram of an exemplary glass wafer used to explain the definition of total thickness variation (TTV).

FIG. 9 shows a flow diagram of a method for forming a glass stack in accordance with some embodiments of the present disclosure.

FIG. 10 shows a flow diagram of a method for forming a glass stack in accordance with some embodiments of the present disclosure.

To facilitate understanding, identical reference numerals have been used, where possible, to designate identical elements that are common to the figures. The figures are not drawn to scale and may be simplified for clarity. Any of the elements and features of any embodiment disclosed herein may be beneficially incorporated in other embodiments without further recitation.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom, vertical, horizontal—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

All numerical ranges utilized herein explicitly include all integer values within the range and selection of specific numerical values within the range is contemplated depending on the particular use.

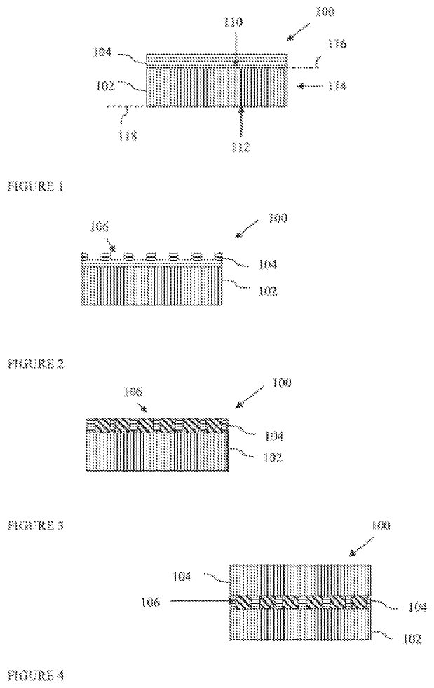

FIG. 1 depicts a schematic representation of a glass-polymer stack 100 in accordance with some embodiments of the present disclosure. The glass-polymer stack 100 comprises a glass article 102 and a polymer material 104 atop a surface of the glass article. In some embodiments, glass article 102 may be a glass sheet. In some embodiments, the glass sheet may be a fusion glass sheet formed using the glass manufacturing apparatus described herein. Glass article 102 includes a first major surface 110, a second major surface 112 opposite to the first major surface 110, and an edge surface 114 extending between the first major surface 110 and the second major surface 112.

In some embodiments, the glass-polymer stack 100 may be formed in a roll to roll process wherein a first glass sheet is stacked atop a second glass sheet. In some embodiments, a polymer material may be applied to the first and/or second glass sheet. In some embodiments, the polymer material is attached to the glass sheet during rolling, for example via a slot-die coating process. In some embodiments, the first glass sheet and the second glass sheets have substantially similar glass characteristics (e.g. warp values, TTV values, bow values, and/or wedge values). As used herein, “substantially similar glass characteristics” refers to values that are within 1% of each other, or within 5% of each other, or within 10% of each other, or within 15% of each other, or within 20% of each other.

In some embodiments, the glass polymer stack 100 is formed by a method 900. FIG. 9 shows a flow diagram of a method 900 for forming a glass stack in accordance with some embodiments of the present disclosure. In some embodiments, method 900 comprises a step 902 of selecting a plurality of portions of a glass sheet having matching glass characteristics, a step 904 of cutting a plurality of glass wafers from the selected portions of the glass sheet, and a step 906 of stacking the plurality of glass wafers to form a glass wafer stack. In some embodiments, method 900 consists of (or consists essentially of) a step 902 of selecting a plurality of portions of a glass sheet having matching glass characteristics, a step 904 of cutting a plurality of glass wafers from the selected portions of the glass sheet, and a step 906 of stacking the plurality of glass wafers to form a glass.

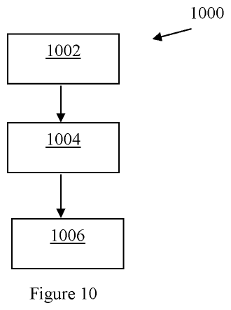

In some embodiments, the glass polymer stack 100 is formed by a method 1000. FIG. 10 shows a flow diagram of a method 1000 for forming a glass stack in accordance with some embodiments of the present disclosure. In some embodiments, method 1000 comprises a step 1002 of cutting a plurality of glass wafers from portions of the glass sheet, a step 1004 of selecting a plurality of glass wafers having a matching glass characteristic, wherein the glass characteristic is at least one of warp, bow, total thickness variation (TTV), and wedge; and a step 1006 of stacking the plurality of glass wafers to form a glass stack. In some embodiments, method 1000 consists of (or consists essentially of) a step 1002 of cutting a plurality of glass wafers from portions of the glass sheet, a step 1004 of selecting a plurality of glass wafers having a matching glass characteristic, wherein the glass characteristic is at least one of warp, bow, total thickness variation (TTV), and wedge; and a step 1006 of stacking the plurality of glass wafers to form a glass stack.

In some embodiments of method 900 or method 1000, a coating is applied onto one or more surfaces of the cut glass wafer and/or the glass sheet. In some embodiments, the coating can be an anti-reflective coating, a reflective coating or a partial reflective coating. In some exemplary embodiments, the coating is MgF₂ or Al₂O₃.

In some embodiments, the glass characteristic is at least one of warp, total thickness variation (TTV), bow, and wedge. As used herein, “selecting matching glass characteristics” refers to selecting portions of the glass having warp values, TTV values, bow values, and/or wedge values that maximizes the geometric flatness value of the final glass stack. In some embodiments, selecting matching glass characteristics can include selecting a first portion of a glass sheet having a first glass characteristic to compensate for a selected second portion of the glass sheet having a second glass characteristic to maximize the geometric flatness value of the final glass stack. An example of selecting matching glass characteristics can include selecting a first portion of a glass sheet having a concave bow profile to match a selected second portion of the glass sheet having a convex bow profile to maximize the geometric flatness value of the final glass stack.

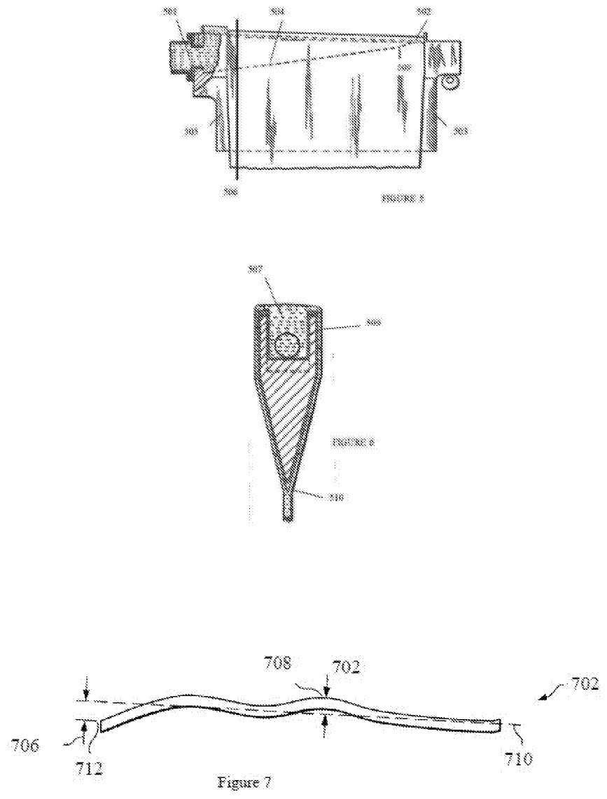

Warp is a glass sheet defect characterized by deviation from a plane. Referring to FIG. 7, there is a schematic diagram of a glass wafer 702 used to explain warp which is defined as a sum of the absolute values of the maximum distances 704 and 706 which are respectively measured between a highest point 708 and a least squares focal plane 710 (dashed line) applied to a shape of the glass wafer 702 and a lowest point 712 and the least squares focal plane 710 (dashed line). The highest point 708 and the lowest point 712 are both with respect to the same surface of the glass wafer 702. The least squares focal plane 710 is applied to the shape of the unclamped (free state) glass wafer 702. The least squares focal plane 710 is determined by the following method. A plane is determined by the equation z=A+Bx−Cy. Then, the least squares planar fit is determined through matrix minimization of the sum of the squares of the deviations of the real data from the plane. This method finds the least squares values A, B, and C. The matrices are determined as follows:

$$[ \begin{matrix}n & Σ {x}_{j} & Σ {y}_{j} \\ Σ {x}_{j} & Σ {x}_{j}^{2} & Σ {x}_{j} * Σ {y}_{j} \\ Σ {y}_{j} & Σ {x}_{j} * Σ {y}_{j} & Σ {y}_{j}^{2}\end{matrix} ] * [ \begin{matrix}A \\ B \\ C\end{matrix} ] z$$

By solving this equation for A, B, and C, the least squares fit is complete.

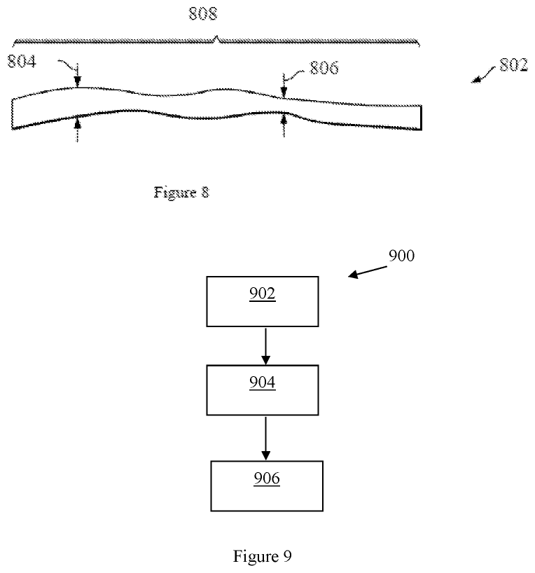

Referring to FIG. 8, there is a schematic diagram of a glass wafer 802 used to explain TTV which is defined to be the difference between a highest thickness (Tmax) elevation 804 and a lowest thickness (Tmin) elevation 806 on the entire surface 808 of the unclamped (free state) glass wafer 802.

“Bow” is defined as the concavity or deformation of the wafer as measured from the center of the wafer, independent of any thickness variation.

In certain exemplary embodiments, glass article 102 has a thickness (i.e., the distance between first major surface 110 and second major surface 112) of less than about 1 mm. In some embodiments, glass article 102 has a thickness of about 0.1 mm to about 1 mm, or about 0.2 mm to about 1 mm, or about 0.3 mm to about 1 mm, or about 0.4 mm to about 1 mm, or about 0.5 mm to about 1 mm, or about 0.6 mm to about 1 mm, or about 0.7 mm to about 1 mm, or about 0.8 mm to about 1 mm, or about 0.9 mm to about 1 mm.

In some embodiments, glass article 102 has a thickness of about 0.1 mm to about 0.9 mm, or about 0.1 mm to about 0.8 mm, or about 0.1 mm to about 0.7 mm, or about 0.1 mm to about 0.6 mm, or about 0.1 mm to about 0.5 mm, or about 0.1 mm to about 0.4 mm, or about 0.1 mm to about 0.3 mm, or about 0.1 mm to about 0.2 mm.

In some embodiments, the glass article 102 comprises (or consists, or consists essentially of) SiO₂ from about 61 wt. % to about 62 wt. %, Al₂O₃ from about 18 wt. % to about 18.4 wt. %, B₂O₃ from about 7.1 wt. % to about 8.3 wt. %, MgO from about 1.9 wt. % to about 2.2 wt. %, CaO from about 6.5 wt. % to about 6.9 wt. %, SrO from about 2.5 wt. % to about 3.6 wt. %, BaO from about 0.6 wt. % to about 1.0 wt. %, and SnO₂ from about 0.1 wt. % to about 0.2 wt. %.

In some embodiments, the glass article 102 comprises (or consists, or consists essentially of) SiO₂ from about 67.8 mol % to about 68.2 mol %, Al₂O₃ from about 11.6 mol % to about 11.9 mol %, B₂O₃ from about 6.7 mol % to about 7.8 mol %, MgO from about 3.1 mol % to about 3.6 mol %, CaO from about 7.0 mol % to about 7.6 mol %, SrO from about 1.6 mol % to about 2.3 mol %, BaO from about 0.3 mol % to about 0.4 mol %, and SnO₂ from about 0.05 mol % to about 0.2 mol %.

In the glass compositions described herein, SiO₂ serves as the basic glass former. In some embodiments, the glass article 102 comprises SiO₂ from about 55 wt. % to about 68 wt. %, or preferably from about 61 wt. % to about 62 wt. %.

Al₂O₃ is another glass former used to make the glasses described herein. In some embodiments, the glass article 102 comprises Al₂O₃ from about 16 wt. % to about 20 wt. %.

B₂O₃ is both a glass former and a flux that aids melting and lowers the melting temperature. It has an impact on both liquidus temperature and viscosity. Increasing B₂O₃ can be used to increase the liquidus viscosity of a glass. In some embodiments, the glass article 102 comprises B₂O₃ from about 6 wt. % to about 9.5 wt. %, or preferably from about 7.1 wt. % to about 8.3 wt. %.

In some embodiments, the glass article 102 comprises three alkaline earth oxides, MgO, CaO, SrO, and BaO. The alkaline earth oxides provide the glass with various properties important to melting, fining, forming, and ultimate use.

In some embodiments, the glass article 102 comprises MgO from about 1 wt. % to about 3 wt. %, or preferably from about 1.9 wt. % to about 2.2 wt. %.

In some embodiments, the glass article 102 comprises CaO from about 5.5 wt. % to about 8 wt. %, or preferably from about 6.5 wt. % to about 6.9 wt. %.

In some embodiments, the glass article 102 comprises SrO from about 1.5 wt. % to about 4.5 wt. %, or preferably from about 2.5 wt. % to about 3.6 wt. %.

In some embodiments, the glass article 102 comprises BaO from about 0.1 wt. % to about 2 wt. %, or preferably from about 0.6 wt. % to about 1.0 wt. %.

In some embodiments, the glass article 102 comprises SnO₂ from about 0.01 wt. % to about 0.5 wt. %, or preferably from about 0.1 wt. % to about 0.2 wt. %.

In some embodiments, the glass article 102 has a refractive index of about 1.515 to about 1.517 at an optical wavelength of about 589 nm. The refractive index is defined as n=c/v, where c is the speed of light in vacuum and v is the phase velocity of light in the subject medium. In some embodiments, the glass article 102 has a refractive index of about 1.516 to about 1.517 at an optical wavelength of about 589 nm. In some embodiments, the glass article 102 has a refractive index of about 1.5155 to about 1.5175 at an optical wavelength of about 589 nm.

In some embodiments, the glass article 102 has an Abbe number (V_{D}) of about 57 to about 67. In some embodiments, the glass article 102 has an Abbe number (V_{D}) of about 60 to about 64. As used herein, Abbe number (V_{D}), also known as the V-number or constringence of a transparent material, is a measure of the material's dispersion (variation of refractive index versus wavelength). The Abbe number of a material is defined as:

$${V}_{D} = \frac{{n}_{D} - 1}{{n}_{F} - {n}_{C}}$$

where n_{D}, n_{F} and n_{C} are the refractive indices of the material at the wavelengths of the Fraunhofer D-, F- and C- spectral lines (589.3 nm, 486.1 nm and 656.3 nm respectively

In some embodiments, the glass articles described herein are characterized by several metrics when being assessed for flatness and roughness. Such metrics can include but are not limited to total thickness variation (TTV), warp, and wedge.

As described above, total thickness variation (TTV) refers to the difference between the maximum thickness and the minimum thickness of a glass sheet across a defined interval υ, typically an entire width of the glass sheet. In some embodiments, the glass article 102 has as-formed geometrical properties of less than or equal to about 5 μm total thickness variation over a component diameter of about 200 mm. In some embodiments, the glass article 102 has as-formed geometrical properties of less than or equal to about 5 μm total thickness variation over a component diameter of about 300 mm.

As discussed above, warp is the difference between a negative out of plane maximum as indicated at 118 (in FIG. 1) for glass article 102 and a positive out of plane maximum as indicated at 116 for glass article 102. In some embodiments, the glass article 102 has as-formed geometrical properties of less than or equal to about 20 μm warp over a component diameter of about 200 mm. In some embodiments, the glass article 102 has as-formed geometrical properties of less than or equal to about 20 μm warp over a component diameter of about 300 mm.

In some embodiments, the component refers to a defined size of a glass sheet (or a portion thereof) from which glass article 102 (e.g. 200 mm or 300 mm diameter) is formed. In some embodiments, the component refers to the glass article 102 cut from a larger diameter glass sheet (e.g. 200 mm or 300 mm diameter).

In some embodiments, the glass article 102 has as-formed geometrical properties of wedge less than or equal to about 0.1 arcmin. As used herein, wedge refers to an asymmentry between the “mechanical axis” of the glass article as defined by the outer edge of the glass article and the optical axis as defined by the optical surfaces.

In some embodiments, the glass article 102 comprises one of a circular, a rectangular, a square, a triangular, or a free-form (e.g. any shape that is not circular, a rectangular, a square, a triangular) shape. The shape of the planar glass component is only limited by the glass shaping/cutting technology being used to produce the planar glass component.

In some embodiments, as depicted in FIG. 1, a polymer material 104 is disposed atop (i.e. is in direct contact) with the first major surface 110 of the glass article 102. In some embodiments, the polymer material 104 has similar refractive index properties as the glass article 102. In some embodiments, the polymer material 104 has a refractive index of about 1.515 to about 1.517 at an optical wavelength of about 589 nm. In some embodiments, the polymer material 104 has a refractive index of about 1.516 to about 1.517 at an optical wavelength of about 589 nm. In some embodiments, the glass article 102 has a refractive index of about 1.5155 to about 1.5175 at an optical wavelength of about 589 nm.

In some embodiments, the polymer material comprises at least one optical structure. FIGS. 2-3 depict a schematic representation of a glass-polymer stack 100 having at least one optical structure 106 in accordance with some embodiments of the present disclosure. In some embodiments, the optical structure 106 can be formed using techniques such as such as nano-replication techniques and holographic techniques. FIG. 2 depicts a glass-polymer stack 100 having surface relief optical structure. In some embodiments, the surface relief optical structure is a grating. In some embodiments, the optical structure 106 is an optical holographic structure. FIG. 3 depicts a glass-polymer stack 100 having a plurality of optical structures in the volume of the polymer such as gratings and optical holographic structure (or holograms). In some embodiments, multiple holograms can be recorded in the polymer material 104 layers of the glass-polymer stack 100.

In some embodiments, the glass-polymer stack is not limited to a single glass article 102 layer and single optical material 104 layer as depicted in FIGS. 1-3. In some embodiments, a glass-polymer stack may include a plurality of glass article 102 layers and/or a plurality of optical material layers 104. In some embodiments, multiple glass-polymer layers can also be stacked (e.g. glass-polymer-glass, or glass-polymer-glass-polymer) to allow multiple holographically defined optical structures to be produced in separate and distinct physical layers of the stack. For example, FIG. 4 depicts a schematic representation of a glass-polymer-glass stack having an optical structure in accordance with some embodiments of the present disclosure.

The embodiments of the disclosure described herein advantageously provide a glass article having the composition and attributes described herein. These attributes combined with the ability to produce arbitrarily shaped glass articles are clear advantage for the applications such as optical light guide based augmented reality optical devices and for optical lightguide based back-lights for mobile devices. The ability to combine glass optical attributes with as-formed, advantaged glass article geometrical attributes enables the lowest cost path to lightguide solutions that preserve optical ray angles inside of the glass plate such that the rays exiting the stack all maintain their relative alignment.

In one embodiment, exemplary glasses are manufactured into sheet via the fusion process. The fusion draw process may result in a pristine, fire-polished glass surface that reduces surface-mediated distortion to high resolution TFT backplanes and color filters. FIG. 5 is a schematic drawing of a forming mandrel, or isopipe, in a non-limiting fusion draw process. FIG. 6 is a schematic cross-section of the isopipe near position 506 in FIG. 5. Glass is introduced from the inlet 501, flows along the bottom of the trough 504 formed by the weir walls 509 to the compression end 502. Glass overflows the weir walls 509 on either side of the isopipe (see FIG. 6), and the two streams of glass join or fuse at the root 510. Edge directors 503 at either end of the isopipe serve to cool the glass and create a thicker strip at the edge called a bead. The bead is pulled down by pulling rolls, hence enabling sheet formation at high viscosity. By adjusting the rate at which sheet is pulled off the isopipe, it is possible to use the fusion draw process to produce a very wide range of thicknesses at a fixed melting rate.

The downdraw sheet drawing processes and, in particular, the fusion process described in U.S. Pat. Nos. 3,338,696 and 3,682,609 (both to Dockerty), which are incorporated by reference, can be used herein. Without being bound by any particular theory of operation, it is believed that the fusion process can produce glass substrates that do not require polishing. Current glass substrate polishing is capable of producing glass substrates having an average surface roughness greater than about 0.5 nm (Ra), as measured by atomic force microscopy. The glass substrates produced by the fusion process have an average surface roughness as measured by atomic force microscopy of less than 0.5 nm. The substrates also have an average internal stress as measured by optical retardation which is less than or equal to 150 psi. Of course, the claims appended herewith should not be so limited to fusion processes as embodiments described herein are equally applicable to other forming processes such as, but not limited to, float forming processes.

In one embodiment, exemplary glasses are manufactured into sheet form using the fusion process. While exemplary glasses are compatible with the fusion process, they may also be manufactured into sheets or other ware through different manufacturing processes. Such processes include slot draw, float, rolling, and other sheet-forming processes known to those skilled in the art.

Relative to these alternative methods for creating sheets of glass, the fusion process as discussed above is capable of creating very thin, very flat, very uniform sheets with a pristine surface. Slot draw also can result in a pristine surface, but due to change in orifice shape over time, accumulation of volatile debris at the orifice-glass interface, and the challenge of creating an orifice to deliver truly flat glass, the dimensional uniformity and surface quality of slot-drawn glass are generally inferior to fusion-drawn glass. The float process is capable of delivering very large, uniform sheets, but the surface is substantially compromised by contact with the float bath on one side, and by exposure to condensation products from the float bath on the other side. This means that float glass must be polished for use in high performance display applications.

The fusion process may involve rapid cooling of the glass from high temperature, resulting in a high fictive temperature T_{f}. The fictive temperature can be thought of as representing the discrepancy between the structural state of the glass and the state it would assume if fully relaxed at the temperature of interest. Reheating a glass with a glass transition temperature T_{g} to a process temperature Tₚ such that Tₚ<T_{g}≤T_{f} may be affected by the viscosity of the glass. Since Tₚ<T_{f}, the structural state of the glass is out of equilibrium at Tₚ, and the glass will spontaneously relax toward a structural state that is in equilibrium at Tₚ. The rate of this relaxation scales inversely with the effective viscosity of the glass at Tₚ, such that high viscosity results in a slow rate of relaxation, and a low viscosity results in a fast rate of relaxation. The effective viscosity varies inversely with the fictive temperature of the glass, such that a low fictive temperature results in a high viscosity, and a high fictive temperature results in a comparatively low viscosity. Therefore, the rate of relaxation at Tₚ scales directly with the fictive temperature of the glass. A process that introduces a high fictive temperature results in a comparatively high rate of relaxation when the glass is reheated at Tₚ.

One means to reduce the rate of relaxation at Tₚ is to increase the viscosity of the glass at that temperature. The annealing point of a glass represents the temperature at which the glass has a viscosity of 10^{13.2} poise. As temperature decreases below the annealing point, the viscosity of the supercooled melt increases. At a fixed temperature below T_{g}, a glass with a higher annealing point has a higher viscosity than a glass with a lower annealing point. Therefore, increasing the annealing point may increase the viscosity of a substrate glass at Tₚ. Generally, the composition changes necessary to increase the annealing point also increase viscosity at all other temperatures. In a non-limiting embodiment, the fictive temperature of a glass made by the fusion process corresponds to a viscosity of about 10¹¹-10¹² poise, so an increase in annealing point for a fusion-compatible glass generally increases its fictive temperature as well. For a given glass regardless of the forming process, higher fictive temperature results in lower viscosity at temperature below T_{g}, and thus increasing fictive temperature works against the viscosity increase that would otherwise be obtained by increasing the annealing point. To have a substantial change in the rate of relaxation at Tₚ, it is generally necessary to make relatively large changes in the annealing point. An aspect of exemplary glasses is that it has an annealing point greater than or equal to about 790° C., 795° C., 800° C. or 805° C. Without being bound by any particular theory of operation, it is believed that such high annealing points results in acceptably low rates of thermal relaxation during low-temperature TFT processing, e.g., typical low-temperature polysilicon rapid thermal anneal cycles.

In addition to its impact on fictive temperature, increasing annealing point also increases temperatures throughout the melting and forming system, particularly the temperatures on the isopipe. For example, Eagle XG® glass and Lotus™ glass (Corning Incorporated, Corning, N.Y.) have annealing points that differ by about 50° C., and the temperature at which they are delivered to the isopipe also differ by about 50° C. When held for extended periods of time above about 1310° C., zircon refractory forming the isopipe shows thermal creep, which can be accelerated by the weight of the isopipe itself plus the weight of the glass on the isopipe. A second aspect of exemplary glasses is that their delivery temperatures are less than or equal to about 1350° C., or 1345° C., or 1340° C., or 1335° C., or 1330° C., or 1325° C., or 1320° C., or 1315° C. or 1310° C. Such delivery temperatures may permit extended manufacturing campaigns without a need to replace the isopipe or extend the time between isopipe replacements.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A method for forming a glass-polymer stack, comprising:
obtaining a glass sheet;
selecting a plurality of portions of the glass sheet having a matching glass characteristic, wherein the glass characteristic is at least one of warp, bow, total thickness variation (TTV), stress, and wedge;
cutting a plurality of glass wafers from the selected portions of the glass sheet; and
stacking the plurality of glass wafers to form a glass stack.

2. The method of claim 1, further comprising applying at least one of an anti-reflective coating, a reflective coating or a partial reflective coating onto one or more surfaces of the cut glass wafer.

3. The method of claim 1, wherein the glass wafer comprises:
SiO₂ from about 61 wt. % to about 62 wt. %;
Al₂O₃ from about 18 wt. % to about 18.4 wt. %;
B₂O₃ from about 7.1 wt. % to about 8.3 wt. %;
MgO from about 1.9 wt. % to about 2.2 wt. %;
CaO from about 6.5 wt. % to about 6.9 wt. %;
SrO from about 2.5 wt. % to about 3.6 wt. %;
BaO from about 0.6 wt. % to about 1.0 wt. %; and
SnO₂ from about 0.1 wt. % to about 0.2 wt. %.

4. The method of claim 3, wherein the glass wafer has a refractive index of about 1.515 to about 1.517 at an optical wavelength of about 589 nm.

5. The method of claim 3, wherein the glass wafer has an Abbe number (V_{D}) of about 57 to about 67.

6. The method of claim 3, wherein the glass wafer has as-formed geometrical properties of;
(a) less than or equal to about 5 μm total thickness variation over a component diameter of about 200 mm;
(b) less than or equal to about 20 μm warp over a component diameter of about 200 mm; and
(c) wedge less than or equal to about 0.1 arcmin.

7. The method of claim 3, wherein the glass wafer has a thickness of about 0.1 mm to about 1 mm.

8. The method of claim 2, wherein the glass wafer comprises a surface having a polymer material with a refractive index of about 1.515 to about 1.517 at an optical wavelength of about 589 nm.

9. The method of claim 8, wherein the polymer material comprises at least one of a surface relief structure or an optical holographic structure.

10. The method of claim 1, wherein the glass stack comprises a plurality of alternating glass layers and polymer material layers.

11. A method for forming a glass-polymer stack, comprising:
obtaining a glass sheet;
cutting a plurality of glass wafers from portions of the glass sheet;
selecting a plurality of glass wafers having a matching glass characteristic, wherein the glass characteristic is at least one of warp, bow, total thickness variation (TTV), and wedge; and
stacking the plurality of glass wafers to form a glass stack.

12. The method of claim 11, further comprising applying one of an anti-reflective coating, a reflective coating or a partial reflective coating onto one or more surfaces of the cut glass wafer.

13. The method of claim 11, wherein the glass wafer comprises:
SiO₂ from about 61 wt. % to about 62 wt. %;
Al₂O₃ from about 18 wt. % to about 18.4 wt. %;
B₂O₃ from about 7.1 wt. % to about 8.3 wt. %;
MgO from about 1.9 wt. % to about 2.2 wt. %;
CaO from about 6.5 wt. % to about 6.9 wt. %;
SrO from about 2.5 wt. % to about 3.6 wt. %;
BaO from about 0.6 wt. % to about 1.0 wt. %; and
SnO₂ from about 0.1 wt. % to about 0.2 wt. %.

14. The method of claim 11, wherein the glass wafer has a refractive index of about 1.515 to about 1.517 at an optical wavelength of about 589 nm.

15. The method of claim 11, wherein the glass wafer has an Abbe number (V_{D}) of about 57 to about 67.

16. The method of claim 11, wherein the glass wafer has as-formed geometrical properties of;
(a) less than or equal to about 5 μm total thickness variation over a component diameter of about 200 mm;
(b) less than or equal to about 20 μm warp over a component diameter of about 200 mm; and
(c) wedge less than or equal to about 0.1 arcmin.

17. The method of claim 11, wherein the glass wafer has a thickness of about 0.1 mm to about 1 mm.

18. The method of claim 11, wherein the glass wafer comprises a surface having a polymer material with a refractive index of about 1.515 to about 1.517 at an optical wavelength of about 589 nm.

19. The method of claim 18, wherein the polymer material comprises at least one of a surface relief structure or an optical holographic structure.

20. The method of claim 11, wherein the glass stack comprises a plurality of alternating glass layers and polymer material layers.
